(19) United States
(12) Patent Application Publication
(10) Pub. No.: US 2025/0162564 A1
(43) Pub. Date: May 22, 2025

(54) METHOD FOR MONITORING THE TEMPERATURE OF BRAKES OF LANDING GEAR OF AN AIRCRAFT

(71) Applicant: Airbus Operations (S.A.S.), Toulouse (FR)

(72) Inventor: Mohamed Laraki, Toulouse (FR)

(21) Appl. No.: 18/938,883

(22) Filed: Nov. 6, 2024

(30) Foreign Application Priority Data
Nov. 22, 2023 (FR) 2312882

(51) Int. Cl. B60T 17/22

(52) U.S. Cl. CPC B60T 17/221; B60T 2270/406

(57) ABSTRACT

A device for monitoring a maximum temperature reached during landing by a brake of landing gear of an aircraft. The monitoring device uses a prediction model to estimate a maximum temperature reached by the brake during landing. An error between the estimated maximum temperature and the measured maximum temperature is determined, and if the error is greater than a first predefined threshold, when the measured maximum temperature is greater than the estimated maximum temperature, or a second predefined threshold, when the measured maximum temperature is less than the estimated maximum temperature, and if a total number of errors is greater than a third predefined threshold, then a warning message is generated for attention of the flight crew and/or ground crew. It is thus possible to anticipate maintenance actions on landing-gear components.

### TECHNICAL FIELD

The disclosure herein relates to a method and device for monitoring the temperature of brakes of landing gear, such as for example the main landing gear (MLG) of an aircraft. More particularly, the disclosure herein relates to detecting, for each of the brakes of given landing gear, a difference between an estimated maximum temperature of a brake and a measured real maximum temperature of the brake.

### BACKGROUND

The main function of landing gear is to allow an aircraft to move over the ground. In particular, landing gear makes it possible to: move between various places in an aerodrome (i.e. towing, taxiing, etc.), perform the take-off roll, damp the impact of landing, and, by virtue of an associated braking system, stop the aircraft over an acceptable distance.

Generally, each wheel of the landing gear is equipped with a braking system in particular comprising brakes, and temperature sensors located on or in proximity to these brakes. When the brakes of the landing gear are activated, their temperature increases. The temperature sensors therefore measure the temperature of each brake individually and then transmit these measurements to respective brake temperature monitoring units located in the landing gear. In one example, the landing gear comprises four wheels and therefore four brakes and therefore four associated monitoring units. Each monitoring unit then transmits brake-temperature data to one braking and steering control unit, the latter being integrated into avionics systems of the aircraft.

Before a take-off, to ensure safe operation of the aircraft and to avoid lowering its performance, the brakes must not exceed a limiting temperature (for example, greater than 400° C.). It may for example be a question of preventing the brakes from heating to temperatures above their safe operating range.

The braking and steering control unit monitors the variation in the temperature of the brakes during a given landing, but also over a predefined period during which a number of landings have taken place.

Thus, after landing, when the temperature of at least one of the brakes of the landing gear is greater than the predefined threshold, the braking and steering control unit transmits via a human-machine interface of the electronic centralized aircraft monitor (ECAM) a warning message for the attention of the flight crew in the event of abnormal behavior of the brakes. For example, if the temperature of a brake is greater than 100° C., a message indicating that the aircraft is able to take off appears on a human-machine interface of the ECAM. If the temperature exceeds 300° C., a message indicating that take-off must be delayed to allow the brakes to cool appear on the human-machine interface of the ECAM.

In another example, the braking and steering control unit makes it possible to detect any asymmetry in the temperature of the brakes of given landing gear. An asymmetry may be the result of abnormal braking conditions such as: oxidation of the brake lining, residual braking or loose brakes. Thus, if the temperature asymmetry between the brakes reaches a predefined maintenance threshold, denoted S (150° C. for example), then a warning message, generated by the braking and steering control unit and then transmitted to the ECAM for example, indicates that a maintenance action or check is required (for example: brake repair, brake replacement, etc.).

However, with this technique, it is difficult to accurately identify which brake, or which other equipment of the landing gear (for example: wheel, braking-system equipment, etc.) of the landing gear is generating the temperature asymmetry between the brakes and requires a maintenance action or check (for example: repair, replacement, etc.).

Specifically, an abnormally high maximum temperature for one brake may influence the value of the maximum temperature of another brake of the landing gear.

It would thus be desirable to overcome these drawbacks of the prior art.

In would in particular be desirable to provide a solution allowing the variation over time in the maximum temperature of each brake of given landing gear to be monitored individually and thus the maintenance actions to be performed on brakes or any other equipment of the landing gear (for example: wheels, sensors, etc.) to be anticipated. Furthermore, it would be desirable to provide a solution allowing which brake, or which other equipment of the landing gear (for example: wheels, sensors, etc.), requires a maintenance action or check to be accurately identified.

### SUMMARY

A method for monitoring a maximum temperature reached during landing by a brake of landing gear of an aircraft is provided here. The method is implemented by a monitoring device. The method comprises:

a phase of using a prediction model to predict a maximum temperature reached by the brake during landing, comprising the following steps
obtaining a current set of values of a plurality of braking parameters, for a current landing;
estimating, by virtue of the prediction model, a maximum temperature that should be reached by the brake during landing, on the basis of the values of the current set.

The method further comprises a comparing phase comprising:
obtaining a measured maximum temperature reached by the brake during the current landing;
determining whether an error between the estimated maximum temperature and the measured maximum temperature is greater than a first predefined threshold S1, when the measured maximum temperature is greater than the estimated maximum temperature, or a second predefined threshold S2, when the measured maximum temperature is less than the estimated maximum temperature;
when the error is greater than the first predefined threshold S1 or second predefined threshold S2, determining whether, in a set of landings containing a number N of landings in a sliding window and the current landing, a total number of errors is greater than a third predefined threshold S3, otherwise reiterating the phase of using the prediction model and the comparing phase for a subsequent landing;
when the total number of errors is greater than the third predefined threshold S3, generating a warning message, otherwise reiterating the phase of using the prediction model and the comparing phase for a subsequent landing.

Thus, it is possible to monitor the temperature of each brake of the landing gear on landing of each wheel independently. A warning is then generated when a large difference is observed between the measured temperature and the estimated temperature of the analyzed brake, this making it possible to anticipate maintenance operations on the various elements of the landing gear.

According to an embodiment, prior to the phase of using the prediction model, the method comprises a phase of training a machine-learning model comprising: associating a set of reference values of brake parameters that was obtained for each landing of a set of reference landings with a reference maximum-temperature value that was reached by the brake of the landing gear during the landing in question.

In an embodiment, estimating the maximum temperature reached by the brake for the current landing, on the basis of the values of the current set of braking parameters, further comprises: computing a weighted sum between the maximum temperature estimated for the brake and a maximum temperature estimated for another brake of the landing gear.

In an embodiment, the method further comprises determining a synthetic estimated temperature equal to the weighted sum of a moving average, over the sliding window of N landings, of the estimated maximum temperature of the brake and of a measured temperature of the other brake of the landing gear.

In an embodiment, the error between the estimated maximum temperature and the measured maximum temperature is computed by taking a weighted sum of a mean absolute error between a moving average, over the sliding window of N landings, of the maximum temperature reached by the brake and the synthetic estimated temperature, and of a symmetric mean absolute percentage error between the moving average, over the sliding window of N landings, of the maximum temperature reached by the brake and the synthetic estimated temperature.

In an embodiment, the braking parameters are one or more of: a braking energy, a maximum braking power, a duration of activation of the brake fans, a duration of reversal of the thrust of the engines, a duration of the landing, an initial temperature of the brake, a length of time between a time when the maximum brake temperature is reached and a time when a speed of rotation of the wheel reaches the percentile value of 95%, a static air temperature, an average ground speed, a maximum ground speed, a sum of the currents applied by a servovalve of the braking system, an average altitude, a manufacturer's serial number of the aircraft, an identifier of the engine type of the aircraft, an identifier of the model of the aircraft.

In an embodiment, the warning message contains an indication that a maintenance action or check must be performed on the brake, and an indication of a type of maintenance action or check to be performed.

In an embodiment, the method further comprises configuring the warning message so that it indicates:
information on a first category of problem and information on a first category of maintenance action or check to be performed that is appropriate for the first category of problem, when the measured maximum temperature is greater than the estimated maximum temperature and when the error between the estimated maximum temperature and the measured maximum temperature is greater than the first predefined threshold S1, or
information on a second category of problem and information on a second category of maintenance action or check to be performed that is appropriate for the second category of problem, when the measured maximum temperature is less than the estimated maximum temperature and when the error between the estimated maximum temperature and the measured maximum temperature is greater than the second predefined threshold S2.

A device for monitoring a maximum temperature reached during landing by a brake of landing gear of an aircraft is also provided here. The monitoring device comprises electronic circuitry configured to implement:
a phase of using a prediction model to predict a maximum temperature reached by the brake during landing, comprising the following steps:
obtaining a current set of values of a plurality of braking parameters, for a current landing;
estimating, by virtue of the prediction model, a maximum temperature that should be reached by the brake during landing, on the basis of the values of the current set;
the method further comprising a comparing phase comprising:
obtaining a measured maximum temperature reached by the brake during the current landing;
determining whether an error between the estimated maximum temperature and the measured maximum temperature is greater than a first predefined threshold S1, when the measured maximum temperature is greater than the estimated maximum temperature, or a second predefined threshold S2, when the measured maximum temperature is less than the estimated maximum temperature;
when the error is greater than the first predefined threshold S1 or second predefined threshold S2, determining whether, in a set of landings containing a number N of landings in a sliding window and the current landing, a total number of errors is greater than a third predefined threshold S3, otherwise reiterating the phase of using the prediction model and the comparing phase for a subsequent landing;
when the total number of errors is greater than the third predefined threshold S3, generating a warning message, otherwise reiterating the phase of using the prediction model and the comparing phase for a subsequent landing.

An aircraft comprising a monitoring device such as described above according to one embodiment is also provided here.

### BRIEF DESCRIPTION OF THE DRAWINGS

The above-mentioned features of the disclosure herein, as well as others, will become more clearly apparent on reading the following description of at least one example of embodiment, the description being given with reference to the appended drawings, in which:

FIG. 1 illustrates, in the form of a flowchart, the steps of the method for monitoring the maximum temperature of a brake of landing gear of an aircraft during a landing, according to an embodiment;

FIG. 2 illustrates, in the form of a flowchart, a preliminary step of characterizing braking parameters, according to an embodiment;

FIG. 3 illustrates, in the form of a graph, one example of results obtained after implementing the method for monitoring the maximum temperature of a brake of landing gear of an aircraft during a landing, according to an embodiment;

FIG. 4 illustrates, in the form of a graph, another example of results obtained after implementing the method for monitoring the maximum temperature of a brake of landing gear of an aircraft during a landing, according to an embodiment;

FIG. 5 schematically illustrates one example of a hardware architecture of a monitoring device according to an embodiment; and

FIG. 6 schematically illustrates a side view of an aircraft equipped with a monitoring device, according to an embodiment.

### DETAILED DESCRIPTION

The general principle of the disclosure herein relates to monitoring the maximum temperature reached by each of the brakes of given landing gear of an aircraft (for example: the main landing gear), independently of one another, during their activation. More specifically, it is the difference, or error, between a maximum temperature said to be “estimated” and a maximum temperature said to be “real” or “measured” of a brake that is monitored for each brake of the landing gear during activation thereof.

Below, in order to illustrate the method described in the following, activation of the brakes will be considered to have occurred during landing of the aircraft. It will be noted that activation of the brakes of the landing gear of the aircraft may also occur during taxiing, or during a phase of take-off of the aircraft in emergency situations.

Below, the term “landing” or “landing phase” is understood to mean the period extending from the time when the aircraft touches the ground (i.e. flight phase No. 8) to the time when the engines of the aircraft are switched off (i.e. flight phase No. 10). In one embodiment, a margin is allowed before flight phase No. 8 (for example: 1 minute) and/or after flight phase No. 10 (for example: 10 minutes), to make sure the landing is covered in its entirety.

The estimated maximum temperature is obtained by virtue of use, by a monitoring device, denoted DISP, of a model to predict the maximum temperature of a brake that is reached during a landing (also simply referred to as the prediction model below). More particularly, this prediction model is implemented in a machine-learning module of the monitoring device DISP (e.g., artificial-intelligence algorithm). In order to obtain this prediction model, a machine-learning module is trained (training phase) to associate values of parameters, called “braking parameters”, with the maximum temperature reached by each brake of the landing gear as measured during a set of reference landings. At the end of this training phase, the prediction model is used (use phase) to estimate the maximum temperature of each brake of the landing gear, on the basis of new values of the braking parameters obtained for a new landing, this making it possible to compare the maximum temperature thus estimated with a maximum temperature value actually measured during this new landing.

Below, the term “braking parameter” is understood to mean parameters capable of exerting an influence on the temperature of the brakes during the landing of the aircraft (i.e., causing the temperature of the brakes to increase, or causing the temperature of the brakes to decrease during landing). In one example, these braking parameters are: the braking pressure, the static air temperature, the wind speed and direction, the vertical acceleration, the duration of application of a reverse engine thrust, the alternating braking pressure, the duration of activation of an anti-skid system, the duration of activation of a brake fan, the duration of the landing, the gross weight of aircraft, the braking energy, the speed of rotation of the wheels of the landing gear on landing, etc.

By virtue of the prediction model, it is possible to estimate, for each landing, the maximum temperature reached by each of the brakes of the landing gear individually under landing conditions said to be “nominal” for a given type of aircraft (i.e., conventional landing conditions of an aircraft assuming the brakes require no maintenance actions or checks).

Thus, it is possible, for the landing in question, to compare the estimated maximum temperature of each of the brakes with the measured actual maximum temperature of the brakes during landing. Depending on the difference, or error, between the estimated and measured maximum temperatures, a warning message is generated by the monitoring device DISP in order to notify the flight crew (for example via the human-machine interface of the ECAM) and/or ground crew via an air-ground communication, of a need for maintenance and/or a check to be performed on one of the brakes and/or other equipment of the landing gear (for example: wheel, sensor, etc.).

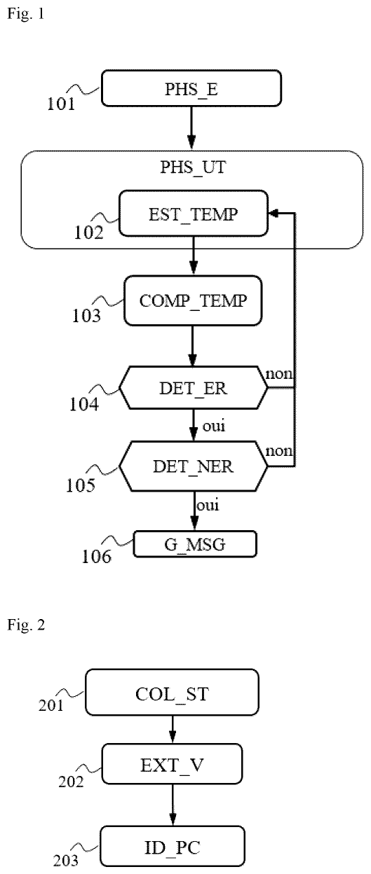

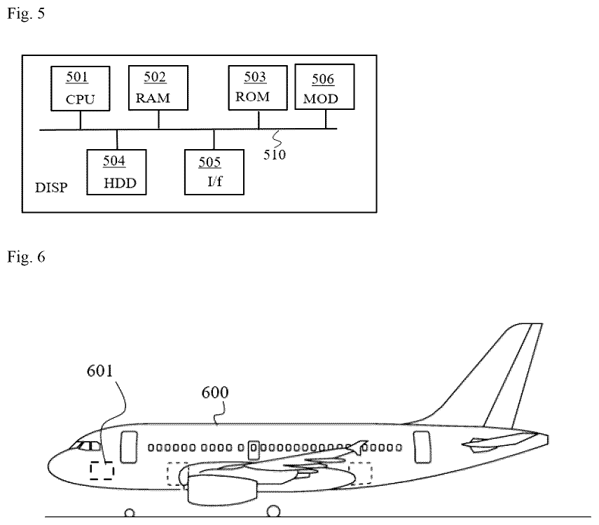

FIG. 1 illustrates, in the form of a flowchart, the steps of the method for monitoring the maximum temperature reached during a landing of the brakes of landing gear according to one embodiment. This method for monitoring the maximum temperature of the brakes is implemented in the monitoring device DISP, which is such as described below with reference to FIG. 5.

The monitoring device DISP comprises electronic circuitry configured in particular to collect, in real time, from one or more sensors (a temperature sensor for example) and/or information systems of the aircraft (for example: the braking and steering control unit (BSCU) or air data computer (ADC)), information on: the temperature of each brake of the landing gear of the aircraft, including the initial temperature of the brakes at the start of the landing phase, and braking parameters (for example: duration of activation of the brake fans, duration of reversal of the thrust of the engines, etc.).

During a preliminary step (not shown), these braking parameters are characterized. These braking parameters will then be used in the phase of training the machine-learning module and the phase of using the prediction model.

It will be noted that, in an embodiment, it is possible to classify these braking parameters according to their influence on the temperature of the brakes during landing. Specifically, certain braking parameters influence the temperature of the brakes to a greater extent than others. Thus, in order to limit the number of data, among the braking parameters identified previously, only those having a greater influence on the temperature of the brakes during landing than others will be used in the phase of training the machine-learning module and the phase of using the prediction model.

FIG. 2 thus illustrates, in the form of a flowchart, a preliminary step of characterizing the braking parameters, according to one embodiment.

During a sub-step 201 COL_ST, data on the braking parameters are obtained from one or more sensors and/or from an information system of the aircraft, such as the ADC. This collection of data is carried out over a predefined period corresponding to a flight window characteristic of the landing phase of the aircraft, such as defined above. Furthermore, this collection of data is carried out at a predefined sampling rate for each braking parameter. Specifically, the sampling rate of the braking parameters depends on the recording frequency of the sensor or system in question, for example 2 Hz.

Thus, for a period corresponding to the landing phase of the aircraft, a time series of values for each braking parameter is obtained.

In order to simplify the prediction model, during a sub-step 202 EXT_V, these time series of values are processed to extract characteristic values of the braking parameters. In other words, a single characteristic value of the braking parameter is extracted instead of considering the variation in the values of the time series for this braking parameter from start to finish. For example, it is possible to extract, from a time series of values corresponding to the variation in the temperature of the brakes throughout the landing phase, by way of a characteristic value, the maximum temperature of the brakes on landing. Generally, from the time series, characteristic values are extracted to be used as input data for the prediction model.

It is thus possible to characterize, during a sub-step 203 ID_PC, braking parameters for the estimation of the maximum temperature of the brakes.

Consequently, at the end of the preliminary step, the braking parameters are characterized so as to be able to be used to train the machine-learning module. Thus, during the phase of using the prediction model, the estimation of the maximum temperature reached by the brakes during the landing phase takes into account these various braking parameters that influence the temperature of the brakes during the landing phase. Thus, the prediction model is trained, then used, to estimate the maximum temperature of the brakes during the landing phase, on the basis of input data (or values) characteristic of the braking parameters.

Thus, during a step 101 PHS_E corresponding to the phase of training the machine-learning module to obtain the prediction model, the latter is trained to associate characteristic values of braking parameters with a measured maximum temperature reached for each landing of a set of landings that serves as reference. This machine-learning model is for example implemented by an artificial-intelligence module MOD 506 of the monitoring device DISP.

To this end, the monitoring device DISP obtains, from one or more sensors and/or information systems of the aircraft (for example: the ADC), for each landing of a set of landings said to be “reference” landings, characteristic values said to be “reference” values of braking parameters and of the maximum temperature of a brake reached during each landing of the set of reference landings. The term “reference landing” is understood to mean a landing for which the values of the braking parameters and of the maximum temperature of the brakes reached during the landings are standard values serving as reference, these values being approved and in conformity with a large number of measurements.

It will be noted that the machine-learning model is trained for each brake of the landing gear independently of the others. Specifically, a brake may have a tendency to behave differently depending on its side, etc. This is why the machine-learning model is trained for each brake independently, and for each aircraft.

Furthermore, all the braking parameters identified during the preliminary stage must be available for the flight to be considered valid for consideration by the machine-learning model. In the contrary case, the flight is considered invalid and the landing data are not taken into account when training the machine-learning model, then when using the prediction model.

Thus, the monitoring device DISP obtains, for each brake of the landing gear and for each landing of the set of reference landings, the reference characteristic values of:
(i) braking parameters such as: the braking energy and the maximum braking power, the duration of activation of the brake fans, the duration of reversal of thrust of the engines; the duration of the landing corresponding to the length of time between the time when the maximum speed of rotation of the wheel associated with the brake is reached and the time when the maximum temperature of the brake is reached, the initial temperature of the brake corresponding to the average of the brake-temperature values obtained during a predefined time interval corresponding to the start of the landing phase; the length of time between the time when the maximum brake temperature is reached and the time when the speed of rotation of the wheel reaches the percentile value of 95%; the static air temperature; the average ground speed; the maximum ground-speed value; sum of the currents applied by a servovalve acting as a hydraulic member controlling the braking system; average altitude (i.e. the average altitude during the landing phase relative to sea level); the manufacturer's serial number (MSN) of the aircraft; an identifier of the engine type of the aircraft (each engine in particular having different thrust-reversal powers); an identifier of the model of the aircraft (each aircraft model having different aerodynamic characteristics, for example);
(ii) the maximum brake temperature reached during landing. It will be noted that if the maximum temperature is less than a predefined minimum temperature, or if the maximum temperature is greater than a predefined maximum temperature, then the flight is considered invalid and the data are not taken into account when training the machine-learning model.

The reference characteristic values of these braking parameters, and the maximum temperature of the brakes, are then used as input data to train the machine-learning model and thus obtain the prediction model.

In one embodiment, these input data are used to train a stacking-regression machine-learning algorithm. Specifically, this type of machine-learning algorithm performs excellently with a mean absolute error of about 15° C. (about 7%). It is an ensemble method that combines a plurality of models, and that consists in stacking the results of each estimator and in using a regressor to compute the final prediction.

The machine-learning model is therefore trained based on the reference characteristic values of the braking parameters and on the maximum temperature of the brakes of the set of reference landings in order to obtain the prediction model. The prediction model is then used in a use phase to estimate the maximum temperature of each brake, for a new landing i (ibeing an integer greater than 0).

Thus, during the phase (denoted PHS_UT) of use of the prediction model by the monitoring device DISP, via its artificial-intelligence module MOD 506, the monitoring device DISP obtains (in the same way as in the training phase described above) the values of the braking parameters, and the maximum temperature reached by each of the brakes of the landing gear for a new landing i.

The monitoring device DISP, on the basis of the braking parameters described above, via the prediction model, estimates, during a step 102 EST_TEMP, a maximum temperature reached by each brake of a landing gear for this new landing i.

However, in order to enhance the estimate of the maximum temperature reached by a brake and to reduce the risk of overadjustment, the maximum braking temperature estimated for a brake is computed by taking a weighted sum of two prediction models of a pair of brakes for the same landing gear. For a given pair of brakes of the landing gear, the weighting factor then defines the weight of each brake in the estimation of the maximum braking temperature. In other words, for an analyzed brake X, the estimated maximum temperature takes into account the maximum estimated temperature, estimated via the prediction model, of another brake Y of the same landing gear.

Once the maximum temperature has been estimated using the prediction model, the monitoring device DISP implements a phase of comparing the estimated and measured temperatures, comprising steps 103 to 106 described below.

During a step 103 COMP_TEMP, for each brake, the monitoring device DISP compares the maximum temperature estimated using the prediction model and the maximum temperature measured in real time during landing i.

More particularly, the monitoring device DISP determines a difference, or an error, between the estimated maximum temperature and the measured maximum temperature for landing i. To this end, the monitoring device DISP determines: the moving average over a sliding window of N (N being an integer greater than 0) landings of the estimated maximum temperature of an analyzed brake (for example brake X), the moving average over the sliding window of N landings of the maximum temperature reached by the analyzed brake, the measured maximum braking temperature of another brake (of the brake pair comprising the analyzed brake and another brake, for example brake Y) of the same landing gear to limit the difference between the estimated maximum braking temperature and that measured on the other brake of the same landing gear.

It will be noted that the measured maximum braking temperature of the other brake is obtained on the basis of the moving average of the estimated maximum temperature of the analyzed brake, of the moving average over the sliding window of N landings of the maximum temperature reached by the other brake and of a parameter making it possible to limit the impact of the actual temperature measured for the other brake on the computation of the error. Without this parameter limiting the actual temperature measured for the other brake, the error would be very high, but only because of the difference between the estimated temperature of the analyzed brake and the measured temperature of the other brake.

It will be noted that the sliding window of N landings corresponds to a fixed number of N landings preceding current landing i, for a given aircraft and a given brake. In other words, for each new flight, the last N flights are taken into account in a sliding manner, i.e. for a flight i+1, flight i is added to the sliding window of N landings and the oldest flight is removed from this sliding window.

Next, according to an embodiment, the monitoring device DISP determines the synthetic estimated temperature by taking the weighted sum of the moving average of the estimated maximum temperature of brake X and of the measured maximum braking temperature of brake Y of the same landing gear. The weighting factor corresponds to the impact of the proportion of brake Y on the estimated maximum braking temperature. On the basis of the moving average of the estimated maximum temperature of the analyzed brake and of the synthetic estimated temperature, the monitoring device DISP determines the mean absolute error (MAE) of the differences between the actual values and the synthetic estimated values, and the symmetric mean absolute percentage error (SMAPE).

Finally, the monitoring device DISP determines the error between the estimated temperature and the measured temperature by taking the weighted sum of the mean absolute error (MAE) and of the symmetric mean absolute percentage error (SMAPE), where the weighting factor is the proportion of absolute and relative errors. Absolute errors facilitate detection of abnormally high temperatures, while relative errors facilitate detection of abnormally low temperatures.

A strategy for detecting brake anomalies is then applied by the monitoring device DISP, based on the error between the measured maximum temperatures and the estimated maximum temperatures of the analyzed brake.

Thus, during a step 104 DET_ER, on the basis of the computation of this error, or difference, between the estimated and measured maximum temperatures of the analyzed brake for the landing of a given current flight i, the monitoring device DISP determines whether this error is greater than:
a first predefined threshold S1, when the measured maximum temperature is greater than the estimated maximum temperature;
a second predefined threshold S2, when the measured maximum temperature is less than the estimated maximum temperature.

It is thus possible to detect various categories of problems with the brakes (or with other equipment of the landing gear) because too high a measured maximum temperature (i.e., the measured maximum temperature is greater than the estimated maximum temperature) and too low a measured maximum temperature (i.e., the measured maximum temperature is less than the estimated maximum temperature) are representative of different problems. To remedy these problems, maintenance or maintenance-checking actions specific to each problem are typically applied.

In one example, when there is substantial wear of the brakes, or piston friction, the brake in question will tend to heat more than expected (i.e., measured maximum temperature greater than the estimated maximum temperature). In another example, when a servovalve or pressure sensor is faulty, the maximum brake temperature may be less than expected (i.e., the measured maximum temperature is less than the estimated maximum temperature).

In another example, a measured maximum temperature less than or greater than the estimated maximum temperature may be representative of a brake-temperature sensor indicating an abnormally very low or, on the contrary, very high temperature (drift for example).

If the measured temperature is greater than the predefined threshold S1 or the predefined threshold S2, then, during step 105 DET_NER, the monitoring device DISP determines whether, during a set of landings comprising the N preceding flights of the sliding window and current flight i, the total number, denoted NT, of times when the error is greater than the predefined threshold S1 or S2 (as the case may be) is greater than a third predefined threshold S3.

Thus, when the number NT is greater than the third predefined threshold S3, then the monitoring device DISP, during step 106 G_MSG, generates a warning message for the attention of the flight crew and/or ground crew. In other words,
a warning message is generated for the brake in question if the measured maximum temperature of the brake is abnormally high, i.e. if the number NT of times the measured temperature of the brake is greater than the estimated maximum temperature plus the predefined threshold S1 (for example: 60° C.) exceeds the predefined threshold S3;
a warning message is generated for the brake in question if the measured maximum temperature of the brake is abnormally low, i.e. if the number NT of times when the measured temperature of the brake is less than the estimated maximum temperature minus a predefined threshold S2 (for example: 60° C.) exceeds the predefined threshold S3.

This warning message is for example transmitted to the ECAM for display on its human-machine interface for the attention of the flight crew. Alternatively or additionally, the warning message is transmitted to a ground control system for display on a human-machine interface for the attention of the ground crew.

In one embodiment, the warning message is a textual message indicating that a brake identified, for example by an identifier, in the warning message has an abnormally high or low temperature and requires a maintenance action or check. In one embodiment, the warning message further contains an indication of a type of maintenance or check to be performed.

In one embodiment, the warning message is configured to reflect the various situations described below (i.e., different message depending on the situation encountered). In particular, such a configured warning message comprises:
information on a first category of problem and information on a first category of maintenance action or check to be performed that is appropriate for the first category of problem, when the measured maximum temperature is greater than the estimated maximum temperature and when the error between the estimated maximum temperature and the measured maximum temperature is greater than the first predefined threshold S1, or
information on a second category of problem and information on a second category of maintenance action or check to be performed that is appropriate for the second category of problem, when the measured maximum temperature is less than the estimated maximum temperature and when the error between the estimated maximum temperature and the measured maximum temperature is greater than the second predefined threshold S2.

In one example, when the error between the estimated maximum temperature and the measured maximum temperature is greater than the first predefined threshold S1, when the measured maximum temperature is greater than the estimated maximum temperature, then the warning message indicates that there is substantial brake wear, or piston friction, or a problem with a temperature sensor, and that action is required to replace or check this equipment.

In one example, when the error between the estimated maximum temperature and the measured maximum temperature is greater than the second predefined threshold S2, when the measured maximum temperature is less than the estimated maximum temperature, then the warning message indicates that there is a problem with a servovalve or temperature sensor of the braking system and that action is required to repair or check the servovalve or temperature sensor.

Only one warning message for a brake and per landing gear is triggered at a time in order to avoid generating multiples warnings for the same problem. An anomaly in one brake (in particular in the case of a brake the temperature of which is below the estimated temperature) may have an impact on the normal braking behavior of another brake of the same landing gear.

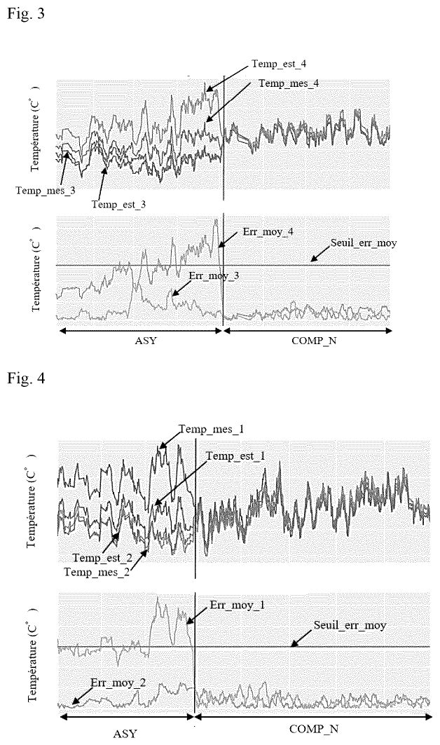

FIG. 3 shows, in graph form, one example of results obtained after implementation of the monitoring method, according to one embodiment.

In this example, the estimated average maximum values of the temperature of brakes number 3 and 4 (denoted Temp_est_3 and Temp_est_4, respectively), and the actual measured values of the temperature of brakes 3 and 4 (denoted Temp_mes_3 and Temp_mes_4, respectively) have been shown for the same aircraft and the same landing gear (see top graph of FIG. 3).

The mean error between the estimated maximum temperature and the measured maximum temperature for brakes 3 and 4 (denoted Err_mean_3 and Err_mean_4, respectively) has also been shown (see bottom graph of FIG. 3).

Apart from the temperature asymmetry between brakes 3 and 4, the prediction model accurately estimates the maximum temperatures of brakes 3 and 4 (COMP_N).

By virtue of use of the prediction model described above, the monitoring device DISP is capable of anticipating a temperature asymmetry between the estimated maximum temperature and the measured maximum temperature for each of the brakes of the landing gear independently and therefore of accurately identifying which brake requires a maintenance action or check.

The temperature error, or difference, between the estimated and measured maximum temperatures of brake 4 continues to increase (ASY) until a warning message is generated. In other words, when the number of times the measured maximum temperature is greater than the estimated maximum temperature by the predefined threshold S1 (60° C. for example) over a plurality of landings is greater than the predefined threshold S3, then the monitoring device DISP generates a warning message.

In contrast, the temperature error, or difference, between the maximum temperatures estimated and measured for brake 3 is small, i.e. less than the predefined threshold S1.

Thus, the monitoring device DISP is capable of accurately detecting which brake requires a maintenance action or check. In this example, brake 4 is the brake that requires the maintenance action or maintenance check.

After the maintenance action or check has been performed, the error, or difference, between the estimated and measured maximum temperatures tends toward low values (COMP_N).

FIG. 4 shows, in graph form, another example of results obtained after implementation of the monitoring method, according to one embodiment.

Prior to the maintenance action (ASY), the measured temperature of brake 1 tends to be greater than the maximum temperature estimated for the brake. This is probably an effect of oxidation on braking, causing brake 1 to heat more than expected. After replacement of the brakes (COMP_N), the prediction model accurately predicts the maximum braking temperature on each landing, which corresponds to the maximum temperature under nominal conditions.

Thus, the monitoring device DISP may, by virtue of use of the prediction model, detect most events resulting in temperature asymmetry between an estimated maximum temperature and a measured maximum temperature with a confidence rate of 100%.

The monitoring device DISP, via the prediction model, is also capable of detecting faults requiring maintenance such as: brake wear, wheel friction and sensor problems. For example, it is possible to detect:
brake wear or wheel friction;
sensor problems;
cases of abnormally cold brakes, for example related to a faulty servovalve or pressure sensor.

FIG. 5 schematically illustrates one example of the hardware architecture of the monitoring device DISP, which then comprises the following, connected by a communication bus 510: a central processing unit CPU 501; a random-access memory RAM 502; a read-only memory ROM 503, for example a flash memory; a device for storing data, such as a hard disk drive HDD or a reader of a storage medium such as a reader of an SD card (SD standing for Secure Digital) 504; at least one communication interface 505 allowing the monitoring device DISP to interact with various sensors and/or avionic systems.

The processor 501 is capable of executing instructions loaded into the RAM 502 from the ROM 503, from an external memory (not shown), from a storage medium such as an SD card, or from a communication network (not shown). When the monitoring device DISP is powered up, the processor 501 is capable of reading instructions from the RAM 502 and of executing them. These instructions form a computer program that causes the processor 501 to implement the behaviors, steps and algorithm described here.

In one embodiment, the monitoring device DISP further comprises an artificial-intelligence module MOD 506 configured to implement a machine-learning model during the training phase PHS_E, and then to use the prediction model during the use phase PHS_UT such as described here.

In one variant, the monitoring device DISP comprises the artificial-intelligence module MOD 506 configured to use the prediction model during the use phase PHS_UT such as described here. This artificial-intelligence module MOD 506 is trained beforehand during the training phase PHS_E in a device different from the monitoring device DISP.

All or some of the behaviors, steps and algorithm described here may thus be implemented in software form by executing a set of instructions by a programmable machine, for example a digital signal processor (DSP) or a microcontroller, or be implemented in hardware form by a machine or of a dedicated chip or chipset, such as a field-programmable gate array (FPGA) or application-specific application circuit (ASIC). Generally, the monitoring device DISP comprises electronic circuitry arranged and configured to implement the behaviors, steps and algorithms described here.

In one example of embodiment, the monitoring device DISP may be implemented in parallel with a BTMS, to provide enhanced functionality and/or redundancy.

In one example of embodiment, the monitoring device DISP may be integrated into an avionics system of the aircraft 600, which will be described with reference to FIG. 6, or may be connected to an avionics system in any suitable manner, so that the monitoring device DISP may communicate estimated braking temperature values to the avionics system of the aircraft 600. For example, the monitoring device DISP may be integrated into or connected to a controller of a BTMS of the aircraft 600.

FIG. 6 schematically illustrates a side view of an aircraft 600 equipped with a monitoring device 601, according to one embodiment. According to the embodiment of FIG. 6, the monitoring device 601 belongs to the avionics system of the aircraft 600.

In other examples, the monitoring device DISP may be completely independent of any on-board system of the aircraft 600. In these examples, the monitoring device DISP may form part of an off-board system, such as a portable maintenance device, which may or may not be capable of communicating with the on-board systems of the aircraft 600, or it may comprise a separate on-board system. In these examples, the monitoring device DISP is equipped with suitable structure for receiving control commands and/or for delivering estimated temperature values, such as a display or a user interface.

While at least one example embodiment of the invention(s) is disclosed herein, it should be understood that modifications, substitutions, and alternatives may be apparent to one of ordinary skill in the art and can be made without departing from the scope of this disclosure. This disclosure is intended to cover any adaptations or variations of the example embodiment(s). In addition, in this disclosure, the terms “comprise” or “comprising” do not exclude other elements or steps, the terms “a”, “an” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A method for monitoring a maximum temperature reached during landing by a brake of landing gear of an aircraft, the method being implemented by a monitoring device, the method comprising:
a phase of using a prediction model to predict a maximum temperature reached by the brake during landing, comprising:
obtaining a current set of values of a plurality of braking parameters, for a current landing;
estimating, based on the prediction model, a maximum temperature that should be reached by the brake during landing, based on the values of the current set;
the method further comprising a comparing phase comprising:
obtaining a measured maximum temperature reached by the brake during the current landing;
determining whether an error between the estimated maximum temperature and the measured maximum temperature is greater than a first predefined threshold, when the measured maximum temperature is greater than the estimated maximum temperature, or a second predefined threshold, when the measured maximum temperature is less than the estimated maximum temperature;
when the error is greater than the first predefined threshold or second predefined threshold, determining whether, in a set of landings containing a number of landings in a sliding window and the current landing, a total number of errors is greater than a third predefined threshold, otherwise reiterating the phase of using the prediction model and the comparing phase for a subsequent landing;
when the total number of errors is greater than the third predefined threshold, generating a warning message, otherwise reiterating the phase of using the prediction model and the comparing phase for a subsequent landing.

2. The method according to claim 1, further comprising, prior to the phase of using the prediction model, a phase of training a machine-learning model comprising associating a set of reference values of brake parameters that was obtained for each landing of a set of reference landings with a reference maximum-temperature value that was reached by the brake of the landing gear during the landing in question.

3. The method according to claim 1, wherein estimating the maximum temperature reached by the brake for the current landing, on the basis of the values of the current set of braking parameters, further comprises computing a weighted sum between the maximum temperature estimated for the brake and a maximum temperature estimated for another brake of the landing gear.

4. The method according to claim 3, further comprising determining a synthetic estimated temperature equal to the weighted sum of a moving average, over the sliding window of landings, of the estimated maximum temperature of the brake and of a measured temperature of the other brake of the landing gear.

5. The method according to claim 4, wherein the error between the estimated maximum temperature and the measured maximum temperature is computed by taking a weighted sum of a mean absolute error between a moving average, over the sliding window of landings, of the maximum temperature reached by the brake and the synthetic estimated temperature, and of a symmetric mean absolute percentage error between the moving average, over the sliding window of landings, of the maximum temperature reached by the brake and the synthetic estimated temperature.

6. The method according to claim 1, wherein the braking parameters are one or more of a braking energy, a maximum braking power, a duration of activation of the brake fans, a duration of reversal of the thrust of the engines, a duration of the landing, an initial temperature of the brake, a length of time between a time when the maximum brake temperature is reached and a time when a speed of rotation of the wheel reaches a percentile value of 95%, a static air temperature, an average ground speed, a maximum ground speed, a sum of currents applied by a servovalve of the braking system, an average altitude, a manufacturer's serial number of the aircraft, an identifier of an engine type of the aircraft, an identifier of a model of the aircraft.

7. The method according to claim 1, wherein the warning message contains an indication that a maintenance action or check must be performed on the brake, and an indication of a type of maintenance action or check to be performed.

8. The method according to claim 7, further comprising configuring the warning message so that it indicates:
information on a first category of problem and information on a first category of maintenance action or check to be performed that is appropriate for the first category of problem, when the measured maximum temperature is greater than the estimated maximum temperature and when the error between the estimated maximum temperature and the measured maximum temperature is greater than the first predefined threshold; or
information on a second category of problem and information on a second category of maintenance action or check to be performed that is appropriate for the second category of problem, when the measured maximum temperature is less than the estimated maximum temperature and when the error between the estimated maximum temperature and the measured maximum temperature is greater than the second predefined threshold.

9. A device for monitoring a maximum temperature reached during landing by a brake of landing gear of an aircraft, the monitoring device comprising electronic circuitry configured to implement:
a phase of using a prediction model to predict a maximum temperature reached by the brake during landing, comprising:
obtaining a current set of values of a plurality of braking parameters, for a current landing;
estimating, based on the prediction model, a maximum temperature that should be reached by the brake during landing, based on the values of the current set;
the method further comprising a comparing phase comprising:
obtaining a measured maximum temperature reached by the brake during the current landing;
determining whether an error between the estimated maximum temperature and the measured maximum temperature is greater than a first predefined threshold, when the measured maximum temperature is greater than the estimated maximum temperature, or a second predefined threshold, when the measured maximum temperature is less than the estimated maximum temperature;
when the error is greater than the first predefined threshold or second predefined threshold, determining whether, in a set of landings containing a number of landings in a sliding window and the current landing, a total number of errors is greater than a third predefined threshold, otherwise reiterating the phase of using the prediction model and the comparing phase for a subsequent landing;
when the total number of errors is greater than the third predefined threshold, generating a warning message, otherwise reiterating the phase of using the prediction model and the comparing phase for a subsequent landing.

10. An aircraft comprising the device according to claim 9.
